(19) United States
(12) Patent Application Publication
(10) Pub. No.: US 2023/0138102 A1
(43) Pub. Date: May 4, 2023

(54) METHOD AND SYSTEM FOR MANAGING DECENTRALIZED DATA USING ATTRIBUTE-BASED ENCRYPTION

(71) Applicant: ELECTRONICS AND TELECOMMUNICATIONS RESEARCH INSTITUTE, Daejeon (KR)

(72) Inventor: Ki Sung PARK, Daejeon (KR)

(21) Appl. No.: 17/832,766

(22) Filed: Jun. 6, 2022

(30) Foreign Application Priority Data
Nov. 2, 2021 (KR) 10-2021-0148904

(51) Int. Cl. H04L 9/00; H04L 9/40; H04L 9/08; H04L 9/30

(52) U.S. Cl. CPC H04L 9/50; H04L 63/08; H04L 9/0866; H04L 9/0825; H04L 9/0822; H04L 9/3073; H04L 63/0428

(57) ABSTRACT

Provided is a method of managing decentralized data using attribute-based encryption. The method includes generating a ciphertext-policy attribute-based encryption (CP-ABE) key pair, registering the generated CP-ABE key pair with a blockchain, encrypting data based on the CP-ABE key pair, uploading the encrypted data to a decentralized repository, generating a smart contract on the blockchain in response to a data sharing request received from a data sharing requester terminal, and sharing the encrypted data through a data sharer terminal by using the generated smart contract.

### CROSS-REFERENCE TO RELATED APPLICATION

This application claims priority to and the benefit of Korean Patent Application No. 10-2021-0148904, filed on Nov. 2, 2021, the disclosure of which is incorporated herein by reference in its entirety.

### BACKGROUND

### 1. Technical Field

The present disclosure relates to a method and system for managing decentralized data using attribute-based encryption.

### 2. Description of Related Art

The existing data management technology enables a user to previously register his or her own information with a central server, such as a cloud, and provides a data management and sharing service through the corresponding server. However, such data sharing technologies have a problem in that a user needs to obtain permission from a central server whenever the user requires data sharing.

Recently, in order to protect the data sovereignty of a user, a data management technology using attribute-based encryption is researched. In the case of such research, a user may directly set an access level for his or her own data, and may allow only an object that satisfies the corresponding level to decrypt data.

However, even in such a method, data of a user is actually stored in a cloud, and there is a problem in that a public key and a secret key used for attribute-based encryption need to be issued by a key generation organization.

In such a centralized structure, if a key issuing organization or a cloud is exposed to an attacker, there may occur a problem in that encrypted data is decrypted because a user secret key is exposed or access to data is impossible due to an erroneous operation of the cloud.

### SUMMARY

Various embodiments are directed to providing a method of managing decentralized data using attribute-based encryption, which enables data to be shared with another terminal without depending on a central server by directly generating and managing a secret key and a public parameter.

However, an object to be solved by the present disclosure is not limited to the aforementioned object, and other objects may be present.

A method of managing decentralized data using attribute-based encryption according to a first aspect of the present disclosure includes generating a ciphertext-policy attribute-based encryption (CP-ABE) key pair, registering the generated CP-ABE key pair with a blockchain, encrypting data based on the CP-ABE key pair, uploading the encrypted data to a decentralized repository, generating a smart contract on the blockchain in response to a data sharing request received from a data sharing requester terminal, and sharing the encrypted data through a data sharer terminal by using the generated smart contract.

Furthermore, a system for managing decentralized data using attribute-based encryption according to a second aspect of the present disclosure includes a communication module configured to transmit and receive data to and from a data sharing requester terminal, a memory configured to store a program for sharing data by using attribute-based encryption, and a processor configured to generate a ciphertext-policy attribute-based encryption (CP-ABE) key pair, register the generated CP-ABE key pair with a blockchain, encrypt data based on the CP-ABE key pair, upload the encrypted data to a decentralized repository, generate a smart contract on the blockchain in response to a data sharing request received from the data sharing requester terminal, and share data through a data sharer terminal by using the generated smart contract.

A computer program according to another aspect of the present disclosure is combined with a computer, that is, hardware, and executes the method and system for managing decentralized data using attribute-based encryption, and is stored in a computer-readable recording medium.

Other details of the present disclosure are included in the detailed description and the drawings.

According to the aforementioned embodiment of the present disclosure, there are provided a trusted third party (TTP)-free key generation scheme using the blockchain and a user-driven access control scheme using attribute-based encryption. Accordingly, a user can directly generate a key pair without depending on a central server, and can set an access level for data in a user-driven way.

Furthermore, an embodiment of the present disclosure can provide a data browsing record check function through a data sharing scheme based on the smart contract of the blockchain and a blockchain smart contract record. Accordingly, although a user terminal is not turned on, the user can share data through the smart contract, and identify a data sharing record because an access record remains in the smart contract.

The effects of the present disclosure are not limited to the above-mentioned effects, and other effects which are not mentioned herein will be clearly understood by those skilled in the art from the following descriptions.

### BRIEF DESCRIPTION OF THE DRAWINGS

FIG. 1 is a flowchart of a method of managing decentralized data according to an embodiment of the present disclosure.

FIG. 2 is a diagram for describing contents for generating and registering an attribute-based encryption key pair.

FIG. 3 is a diagram illustrating an example of an access tree.

FIG. 4 is a diagram for describing a data encryption process.

FIG. 5 is a diagram for describing a smart contract generation and data sharing process.

FIG. 6 is a diagram for describing a data decryption process.

FIG. 7 is a block diagram for describing a system for managing decentralized data using attribute-based encryption according to an embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the category of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various elements, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms used and defined in common dictionaries are not construed as being ideal or excessively formal unless specially defined otherwise.

The present disclosure relates to a method and system 100 for managing decentralized data using attribute-based encryption.

According to an embodiment of the present disclosure, there is proposed a scheme for enabling a user to directly generate a key for encrypting data without the key issued by a central server, by using a decentralized repository and a blockchain technology. The proposed disclosure has advantages in that a user can share data without using a central server, such as a cloud, by applying an interplanetary file system (IPFS) or a Swarm technology, that is, a decentralized file repository technology, and can manage a data access record by using a blockchain technology.

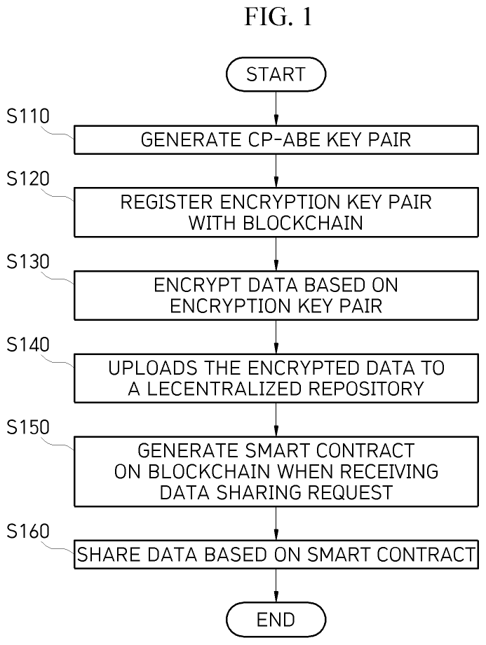

Hereinafter, a method of managing decentralized data using attribute-based encryption according to an embodiment of the present disclosure is described with reference to FIGS. 1 to 6.

FIG. 1 is a flowchart of a method of managing decentralized data according to an embodiment of the present disclosure.

It may be understood that each of steps illustrated in FIG. 1 is performed by a system 100 for managing decentralized data described later, but the present disclosure is not essentially limited thereto. In this case, the system for managing decentralized data may be implemented in the form of a user terminal, but the present disclosure is essentially not limited thereto.

The system for managing decentralized data according to an embodiment of the present disclosure first generates a ciphertext-policy attribute-based encryption (CP-ABE) key pair (S110), and registers the generated CP-ABE key pair with a blockchain (S120).

The attribute-based encryption is divided into key-policy attribute-based encryption (KP-ABE) and ciphertext-policy attribute-based encryption (CP-ABE) depending on a location of an access tree that controls access to a cryptogram. An embodiment of the present disclosure applies the CP-ABE.

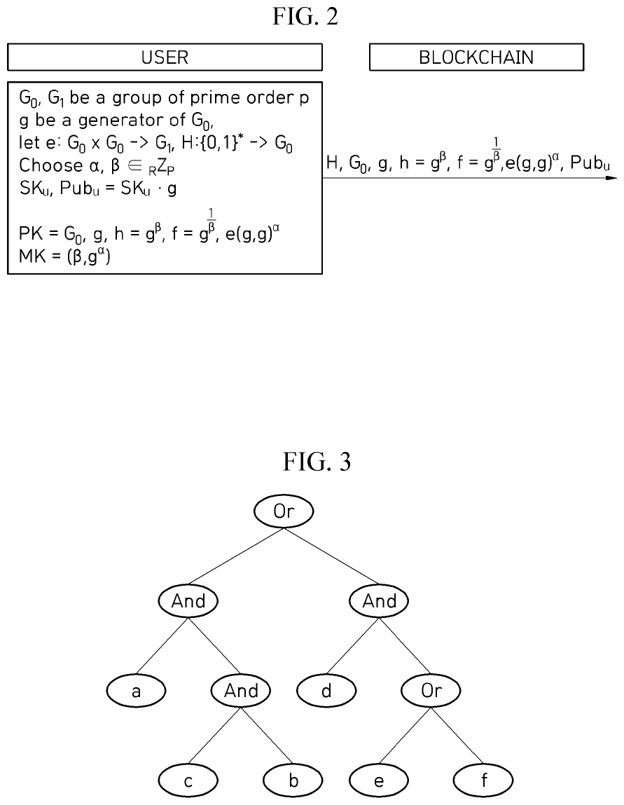

FIG. 2 is a diagram for describing contents for generating and registering an attribute-based encryption key pair.

First, a user selects a bilinear group G₀, G₁, and then generates a bilinear map e: G₀×G₀=G₁ corresponding to the bilinear group.

Furthermore, the user generates his or her own personal key SKᵤ, that is, a generator g, his or her own public key Pubᵤ=SKᵤ·g, and a cryptographic hash function h.

Thereafter, the user generates information on the bilinear group, information on the bilinear map, information on the encryption key pair, and information on the hash function in the form of a public parameter {G₀, e, g, h, f, e(g, g)^{α}, Pubᵤ}, and registers the public parameter with the blockchain. In an embodiment of the present disclosure, data can be shared by using the generated public parameter.

Referring back to FIG. 1, next, the user encrypts data based on the CP-ABE key pair (S130), and uploads the encrypted data to a decentralized repository (S140).

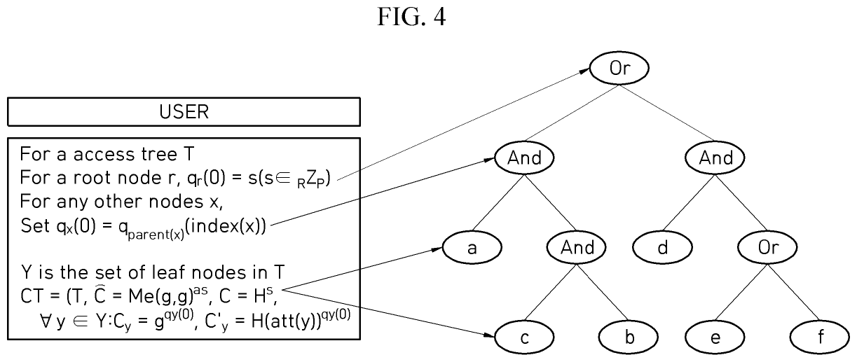

FIG. 3 is a diagram illustrating an example of an access tree. FIG. 4 is a diagram for describing a data encryption process.

A user encrypts his or her own data based on CP-ABE in order to upload his or her own data to a decentralized repository (e.g., an IPFS or Swarm), and uploads the encrypted data to the decentralized repository.

Specifically, the user generates an access tree T for encrypting the data. The access tree is illustrated in FIG. 3, and includes a condition in which the user can access data.

The access tree includes a plurality of nodes each represented as a threshold value. The plurality of nodes may include an AND node whose number of leaf nodes is set as a threshold value, an OR node whose threshold value is set to 1, and a leaf node indicative of a setting condition value of a user for accessing data.

A user terminal first sets a root node r to be used in an access tree T, and obtains a random value s that satisfies a value of a root node q_{R}(0)=s. Furthermore, the user terminal calculates a value qₓ(0)=qₚₐᵣₑₙₜ₍ₓ₎(index(x)) that refers to an upper node value among all nodes except a root node. Thereafter, the user terminal encrypts data by using a set Y of leaf nodes of the generated access tree T. In this case, a generated and calculated cryptogram CT of the access tree is illustrated in FIG. 4.

The user uploads the encrypted data to a decentralized repository, and obtains an address of the decentralized repository by which data can be accessed. For example, in the case of the IPFS, the user obtains content identifiers.

Next, when receiving a data sharing request from a data sharing requester terminal, the user generates a smart contract on the blockchain (S150), and shares data through a data sharer terminal by using the generated smart contract (S160).

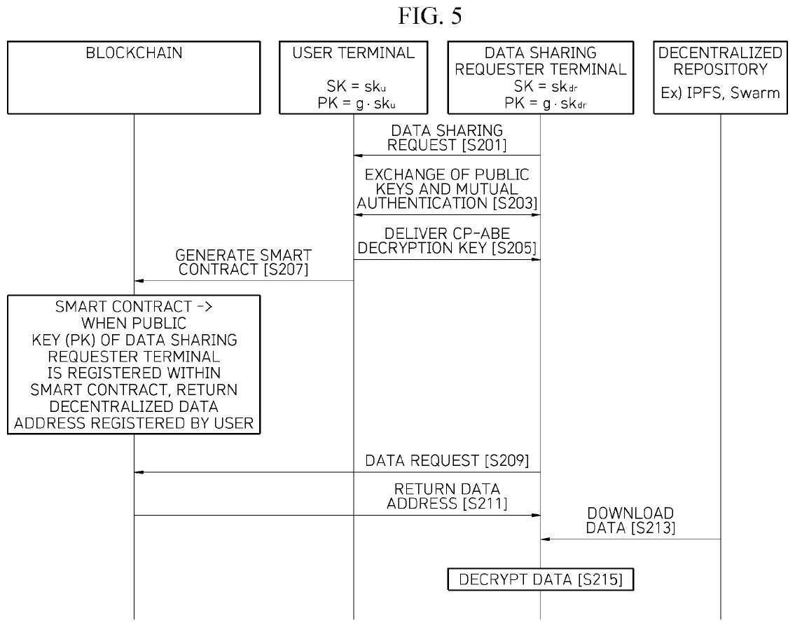

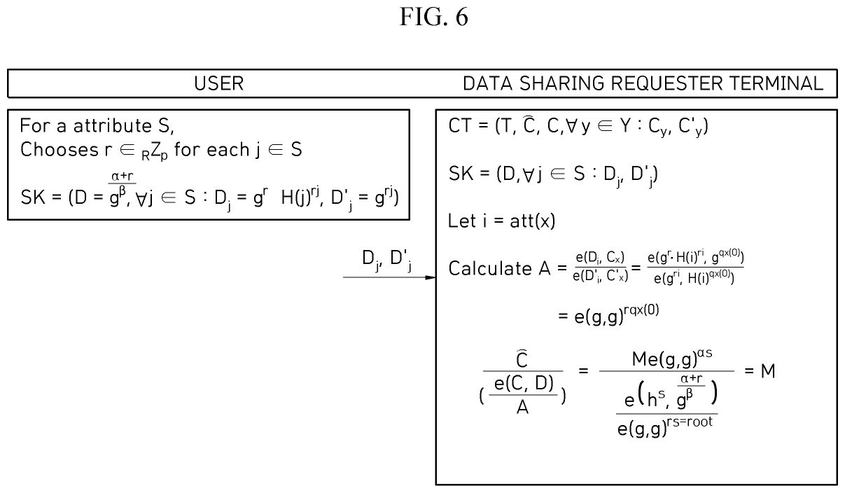

FIG. 5 is a diagram for describing a smart contract generation and data sharing process. FIG. 6 is a diagram for describing a data decryption process.

First, when a data sharing request is received from a data sharing requester terminal (S201), mutual authentication is performed between a user terminal and the data sharing requester terminal, and public keys are exchanged between the user terminal and the data sharing requester terminal (S203). In this case, the exchange of the public keys and the mutual authentication may be performed by using common conventional technologies.

When the exchange of the public keys is completed, the user terminal encrypts, in the form of a symmetric key, a decryption key Dⱼ, Dⱼ′ generated based on the exchanged public keys, and delivers the encrypted symmetric key to the data sharing requester terminal (S205). In this case, the decryption key may be generated by the number of conditions of a data access level in an access tree, and the generated decryption key may be transmitted to the data sharing requester terminal.

Thereafter, when the delivery of the CP-ABE decryption key is completed, the user terminal generates a smart contract on a blockchain (S207). In this case, the user terminal identifies whether an address of a wallet that accesses the smart contract is present in a list within the smart contract, and returns a data address set by the user when the address of the wallet is present. When the address of the wallet is not present, a condition for the smart contract is set so that a null value is returned.

According to such a condition, if a public key of the data sharing requester terminal has been registered with the smart contract, the data sharing requester terminal accesses the smart contract (S209), proves its own address based on an electronic signature, and is provided with a blockchain address stored in the smart contract (S211).

Accordingly, the data sharing requester terminal downloads encrypted data from a decentralized repository by using the blockchain address by requesting the encrypted data (S213), and decrypts the encrypted data by using the previously received CP-ABE decryption key (S215).

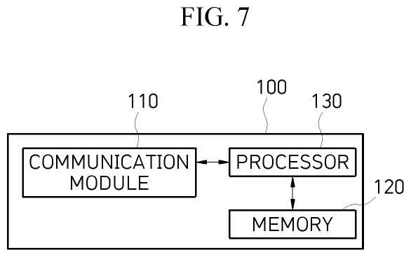

In the aforementioned description, steps S110 to S215 may be further divided into additional steps or combined into smaller steps depending on an implementation example of the present disclosure. Furthermore, some steps may be omitted if necessary, and the sequence among steps may be changed. Furthermore, although other contents are omitted, the contents described with reference to FIGS. 1 to 6 may also be applied to the system 100 for managing decentralized data in FIG. 7.

FIG. 7 is a block diagram for describing the system 100 for managing decentralized data using attribute-based encryption according to an embodiment of the present disclosure.

The system 100 for managing decentralized data according to an embodiment of the present disclosure includes a communication module 110, a memory 120, and a processor 130.

The communication module 110 transmits and receives data to and from a data sharing requester terminal.

The memory 120 stores a program for sharing data by using attribute-based encryption. The processor 130 executes the program stored in the memory 120.

As the program is executed, the processor 130 generates a ciphertext-policy attribute-based encryption (CP-ABE) key pair and registers the CP-ABE key pair with a blockchain, encrypts data based on the CP-ABE key pair, and uploads the encrypted data to a decentralized repository.

Furthermore, when receiving a data sharing request from a data sharing requester terminal, the processor 130 generates a smart contract on the blockchain, and shares data with the data sharing requester terminal through a data sharer terminal by using the generated smart contract.

The aforementioned embodiment of the present disclosure may be implemented in the form of a program (or application) in order to be executed by being combined with a computer, that is, hardware, and may be stored in a medium.

The aforementioned program may include a code coded in a computer language, such as C, C++, JAVA, Ruby, or a machine language which is readable by a processor (CPU) of a computer through a device interface of the computer in order for the computer to read the program and execute the methods implemented as the program. Such a code may include a functional code related to a function, etc. that defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and readable by a device, not a medium storing data for a short moment like a register, cache, or a memory. Specifically, examples of the stored medium include a ROM, a RAM, a CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

What is claimed is:

1. A method of managing decentralized data using attribute-based encryption, the method performed by a computer comprising:
generating a ciphertext-policy attribute-based encryption (CP-ABE) key pair;
registering the generated CP-ABE key pair with a blockchain;
encrypting data based on the CP-ABE key pair;
uploading the encrypted data to a decentralized repository;
generating a smart contract on the blockchain in response to a data sharing request received from a data sharing requester terminal; and
sharing the encrypted data through a data sharer terminal by using the generated smart contract.

2. The method of claim 1, wherein the generating of the CP-ABE key pair comprises:
generating a bilinear map corresponding to a bilinear group selected by a user;
generating information on a personal key of the user, a public key corresponding to the personal key, and a hash function; and
generating information on the bilinear group, the bilinear map, the encryption key pair, and the hash function in a form of a public parameter.

3. The method of claim 2, wherein the registering of the generated CP-ABE key pair with the blockchain comprises registering the generated public parameter with the blockchain.

4. The method of claim 1, wherein the encrypting of the data based on the CP-ABE key pair comprises:
generating an access tree comprising a condition in which a user is able to access data; and
encrypting data based on a set of leaf nodes included in the access tree,
wherein the generating of the access tree comprising the condition in which the user is able to access data comprises:
setting a value of a root node to be used in the access tree; and
calculating an upper node reference value for all nodes except the root node.

5. The method of claim 4, wherein:
the access tree comprises a plurality of nodes each represented as a threshold value, and
the node comprises an AND node whose number of leaf nodes is set as a threshold value, an OR node whose threshold value is set to 1, and a leaf node indicative of a setting condition value of a use for accessing data.

6. The method of claim 4, wherein the sharing of the data through the data sharer terminal by using the generated smart contract comprises:
receiving a data sharing request from the data sharing requester terminal;
performing authentication and exchanging public keys with the data sharing requester terminal;
encrypting, in a form of a symmetric key, a decryption key generated based on the exchanged public keys and transmitting the symmetric key to the data sharing requester terminal; and
providing the data sharer terminal with a blockchain address stored in the smart contract when the public key of the data sharing requester is registered with the smart contract.

7. The method of claim 6, wherein the encrypting of, in the form of the symmetric key, the decryption key generated based on the exchanged public keys and the transmitting of the symmetric key to the data sharing requester terminal comprises:
generating a decryption key by the number of conditions of a data access level in the access tree and transmitting the generated decryption key to the data sharing requester terminal.

8. The method of claim 6, wherein the data sharing requester terminal downloads the encrypted data from a decentralized repository through the blockchain address and decrypts the encrypted data based on the decryption key.

9. A system for managing decentralized data using attribute-based encryption, the system comprising:
a communication module configured to transmit and receive data to and from a data sharing requester terminal;
a memory configured to store a program for sharing data by using attribute-based encryption; and
a processor configured to generate a ciphertext-policy attribute-based encryption (CP-ABE) key pair, register the generated CP-ABE key pair with a blockchain, encrypt data based on the CP-ABE key pair, upload the encrypted data to a decentralized repository, generate a smart contract on the blockchain in response to a data sharing request received from the data sharing requester terminal, and share data through a data sharer terminal by using the generated smart contract.

10. The system of claim 9, wherein the processor is configured to:
generate a bilinear map corresponding to a bilinear group selected by a user terminal,
generate information on a personal key of the user, a public key corresponding to the personal key, and a hash function,
generate information on the bilinear group, information on the bilinear map, information on the encryption key pair, and the information on the hash function in a form of a public parameter, and
register the public parameter with the blockchain.

11. The system of claim 9, wherein the processor is configured to:
generate an access tree comprising a condition in which a user terminal is able to access data, and
encrypt data based on a set of leaf nodes included in the access tree.

12. The system of claim 11, wherein:
the access tree comprises a plurality of nodes each represented as a threshold value, and
the node comprises an AND node whose number of leaf nodes is set as a threshold value, an OR node whose threshold value is set to 1, and a leaf node indicative of a setting condition value of a use for accessing data.

13. The system of claim 11, wherein the processor is configured to:
perform authentication and exchange public keys with the data sharing requester terminal in response to a data sharing request received from the data sharing requester terminal,
encrypt, in a form of a symmetric key, a decryption key generated based on the exchanged public keys and transmitting the symmetric key to the data sharing requester terminal, and
provide the data sharer terminal with a blockchain address stored in the smart contract when the public key of the data sharing requester is registered with the smart contract.

14. The system of claim 13, wherein the processor is configured to:
generate a decryption key by the number of conditions of a data access level in the access tree, and
transmit the generated decryption key to the data sharing requester terminal.

15. The system of claim 13, wherein the data sharing requester terminal downloads the encrypted data from a decentralized repository through the blockchain address and decrypts the encrypted data based on the decryption key.
